(19) United States
(12) Patent Application Publication
(10) Pub. No.: US 2025/0352892 A1
(43) Pub. Date: Nov. 20, 2025

(54) Fluid Adaptive Controller

(71) Applicant: Sony Interactive Entertainment Inc., Tokyo (JP)

(72) Inventors: Jun Yen Leung, London (GB); Maurizio Cerrato, London (GB); Lawrence Martin Green, London (GB); Maria Chiara Monti, London (GB); Patrick John Connor, London (GB); Rajeev Gupta, London (GB)

(21) Appl. No.: 19/206,986

(22) Filed: May 13, 2025

(30) Foreign Application Priority Data
May 14, 2024 (GB) 2406781.1

(51) Int. Cl. A63F 13/285; A63F 13/24

(52) U.S. Cl. CPC A63F 13/285; A63F 13/24

(57) ABSTRACT

The present disclosure relates to a peripheral device for a video game device, the peripheral device comprising: a main reservoir configured to be filled with fluid, and a distribution system connected to the main reservoir and configured to transport fluid to and from the main reservoir, wherein, in use, fluid is transported to and from the main reservoir to adjust a property of the peripheral device.

### CROSS REFERENCE TO RELATED APPLICATIONS

The present application claims priority to United Kingdom (GB) Application No. 2406781.1, filed 14 May 2024, the contents of which is incorporated by reference herein in its entirety for all purposes.

### TECHNICAL FIELD

The present disclosure relates to a peripheral device of a video game device that includes a main reservoir and distribution means to transport fluid to and from the main reservoir, thereby adjusting a property of the peripheral device to increase user immersion.

### BACKGROUND

Some modern video game systems seek to increase immersion through the use of buttons with adaptive resistance and haptic devices, for example.

Buttons with adaptive resistance have dynamic resistance which can be adjusted depending on an action that the user is performing in a virtual environment. For example, if the user is pulling the trigger of an in-game gun, or pulling back a virtual bow, a trigger or button on a controller could have different resistances to movement depending of the type of action. For example, pulling the trigger of a gun might be represented by the controller trigger having an initial high resistance, followed by a lower resistance once the in-game gun has been fired. In contrast, if the user is pulling on the string of a virtual bow, the trigger may be adapted to have an increasing resistance as the virtual string is pulled back, to mimic resistance felt on the fingers when drawing a bow.

This functionality can be achieved by magnetic or mechanical systems. A disadvantage of this is that a separate component is required for each button that has the adaptive feature. This adds weight and cost to the controller, and means there are more components that could potentially require repair. The additional weight also makes it uncomfortable for the user to use the controller for extended periods of time.

Another avenue for increasing immersion is the use of haptic devices such as force feedback devices. Current haptic devices provide limited sensory enhancements, and in particular they do not provide the sensation of touch transmitted to the user. For example, existing hand exoskeleton devices only provide force feedback by mechanically moving fingers, but do not exert a force on the fingertips, and so feel more like being “pulled back” rather than touching an object.

### SUMMARY

Accordingly, the present disclosure provides a peripheral device with a reservoir which is fillable with fluid and a distribution system to transport the fluid to and from the main reservoir. In use, the fluid is transported to and from the main reservoir to alter or adjust a physical property of the peripheral device.

In accordance with a first aspect, a peripheral device for a video game device is provided, the peripheral device comprising: a main reservoir configured to be filled with fluid; and a distribution system connected to the main reservoir and configured to transport fluid to and from the main reservoir, wherein, in use, fluid is transported to and from the main reservoir to adjust a pressure applied to a moveable component of the peripheral device.

The use of fluid to adjust a property of the peripheral device provides fine-grained control over the adjustment of the property of the peripheral device. This is because the distribution system can transfer more or less fluid depending on the amount of adjustment needed. The peripheral device of this specification is therefore more tuneable and can provide greater levels of immersion to the user relative to magnetic, mechanical, and force feedback systems depending on the extent to which the property is adjusted.

Further, this approach reduces the number of moving parts compared to a mechanical approach, and adds less weight to the peripheral device than mechanical and magnetic system. The peripheral device of the disclosure therefore provides adaptive resistance functionality while being more lightweight and less complex than prior approaches.

For example, the peripheral device may comprise a button, wherein the button is connected to the distribution system, wherein the pressure is applied to the button to adjust a resistance to movement of the button, wherein the resistance to movement of the button varies in proportion to an amount of fluid transported from the main reservoir to the button.

In this specification, a “button” can refer to any part of the peripheral device that the user manipulates to provide an input to a video game system. For example, the button could be realised as a button, a trigger, or a joystick.

In this way, the resistance of the button can be adjusted in a fine-grained way, allowing for a wider range of possible resistances. This opens the way for increased immersion by providing a realistic level of resistance that reflects an action being performed by a user of the peripheral device in a virtual environment. For example, difference game mechanics can be associated with different levels of resistance. For example, various kinds of game mechanics, such as drawing a bowstring, pulling the trigger of a gun, opening a door and casting a powerful spell can have corresponding resistance profiles that that are tuned to be more realistic.

In this example, the use of a main reservoir further exemplifies how weight and complexity of the peripheral device is reduced, since by using a main reservoir coupled to a distribution system, the fluid can be redistributed to different buttons according to requirements. It is unlikely that all of the buttons will require adaptive resistance at one time, since the user cannot typically press all of the buttons at the same time. Therefore, the disclosure provides a lower weight and lower complexity approach to adaptive resistance of buttons on peripheral devices.

In this specification, “resistance of movement” can refer to how easy or difficult it is to press or squeeze the button, or squeeze a trigger, or move a joystick. A higher resistance to movement indicates that the button, trigger or joystick is harder to move, while a lower resistance to movement indicates that the button, trigger or joystick is easier to move.

In some cases, the button may comprise a plurality of buttons, the distribution system comprises a plurality of secondary reservoirs, and wherein each of the secondary reservoirs is arranged between the main reservoir and a respective button.

In some situations, an even more fine-grained level of control is required. In such situations, a secondary reservoir can be provided for each button, which exchanges fluid with the main reservoir. By providing a secondary reservoir for each button, more control can be provided in how much the resistance of each button in adjusted.

To further improve immersion, the peripheral device may further comprise a force feedback reservoir connected to the distribution system, wherein the pressure is applied to the force feedback reservoir to adjust a size of the force feedback reservoir, wherein in use, the force feedback reservoir is configured to expand and contract, and the force feedback reservoir is configured to be in contact with a part of a user's body, such that the user feels a sensation when the force feedback reservoir expands and contracts.

By using a force feedback reservoir that contacts a part of the user's body, the sensation of touch is transmitted to the user by expanding and contracting the force feedback reservoir. This further improves immersion in a virtual environment since more of the user's senses are being exposed to events occurring in the virtual environment through the peripheral device. Further, as discussed above, the use of fluid allows for fine-grained control of the distribution of the fluid, which in turn allows for expansion and contraction of the force feedback reservoir to be finely controlled. The user's experience is therefore more aligned with events occurring in the virtual environment, which heightens the user's sense of immersion.

In some examples, the peripheral device further comprises a heater connected to the main reservoir, wherein the heater is configured in use to heat fluid in the main reservoir.

Additionally or alternatively, the peripheral device further comprises a cooling device connected to the main reservoir, wherein the cooling device is configured in use to cool fluid in the main reservoir.

The sensation of temperature can therefore be conveyed to the user, which provides another avenue for increasing immersion. That is, the temperature of the fluid can be controlled to reflect events occurring in a virtual environment.

In some examples, the force feedback reservoir comprises a plurality of force feedback reservoirs.

In this way, immersion is further improved, because the user can sense the expansion and contraction of the force feedback reservoirs at multiple places.

In some examples, the part of the user's body comprises the user's fingertips, wherein the plurality of force feedback reservoirs comprises a respective force feedback reservoir for each of the user's fingertips.

Fingertips are known to have a high density of nerve endings and so experience sensations like touch and temperature strongly. By arranging the plurality of force feedback reservoirs to be in contact with the user's fingertips, the user can experience strong touch sensation and temperature variations without significant increases in the complexity and cost of the peripheral device. Immersion is therefore improved considerably.

Further, the use of expanding and contracting force feedback reservoirs through contact with fingertips conveys the sensation of touch more accurately than existing systems. This is because by providing the contact with the force feedback reservoir on the user's fingertips, when the force feedback reservoir expands, the user will get the impression that the expansion is due to touching or holding an object in the virtual environment. The feeling that the user's hand has been “pulled back” is therefore avoided. Accordingly, the user's sense of immersion is further increased.

In some further examples, the part of the user's body comprises the user's fingers, and the plurality of force feedback reservoirs comprises a plurality of force feedback reservoirs for each of the user's fingers, wherein the plurality of force feedback reservoirs are arranged to contact different locations on each of the fingers.

This provides another layer of granularity to how the present peripheral device can provide increased immersion. That is, by providing force feedback reservoirs at different locations on each finger, different areas of the finger can have different forces exerted on them. This allows for complex sensations to be conveyed from a virtual environment to the real world.

In some examples, the distribution means may comprise a bi-directional pump. In other examples, the distribution means may comprise a motor,

These are an effective way of transporting fluid as needed throughout the peripheral device, and are also low complexity.

Additionally, the force feedback reservoir may be formed from a material comprising silicone. This improves durability of the force feedback reservoir and therefore increases the longevity of the peripheral device.

### BRIEF DESCRIPTION OF DRAWINGS

The peripheral device of this specification will be described with reference to the Figures, in which:

FIG. 1 shows schematic representation of a peripheral device.

FIG. 2 shows a schematic representation of a peripheral device including a main reservoir and distribution means.

FIG. 3 shows a schematic representation of a peripheral device including secondary reservoirs.

FIG. 4 shows a schematic representation of a peripheral device including force feedback reservoirs.

### DETAILED DESCRIPTION

An important part of any video game system is its ability to immerse the user in a virtual environment, such as a virtual reality or a game. This is achieved by stimulating the user's senses so that they feel that they are in the game. A more modern approach is to convey physical sensation from the virtual environment to the real world, i.e. haptic feedback. Examples of the present disclosure provide a fine-grained approach to providing haptic feedback. Two kinds of haptic feedback are discussed in particular, namely adaptive resistance buttons and force feedback reservoirs.

The present disclosure advantageously provides a peripheral device comprising a main reservoir for filling with fluid and a distribution means to transport fluid to and from the main reservoir to adjust a pressure applied to a moveable component of the peripheral device. The use of fluid in this context is particularly advantageous as it allows for a continuous sliding scale of adjustment, compared to prior approaches which are not as tuneable.

Before discussing the specifics of transporting fluid to and from the main reservoir and adjusting a pressure applied to a moveable component, we first describe an example peripheral device.

The present disclosure applies to all kinds of peripheral devices. The disclosures herein will be illustrated primarily with reference to application in video game devices, such as a motion sensing controller, or a video game controller, it will be understood that the peripheral device of this specification may be implemented in other controllers such as remote-controlled vehicles, medical devices and the like. For ease of reference, below we refer to a video game controller or simply to a controller. However, it would be understood by a skilled person that a controller is interchangeable with another kind of peripheral device for a video game device.

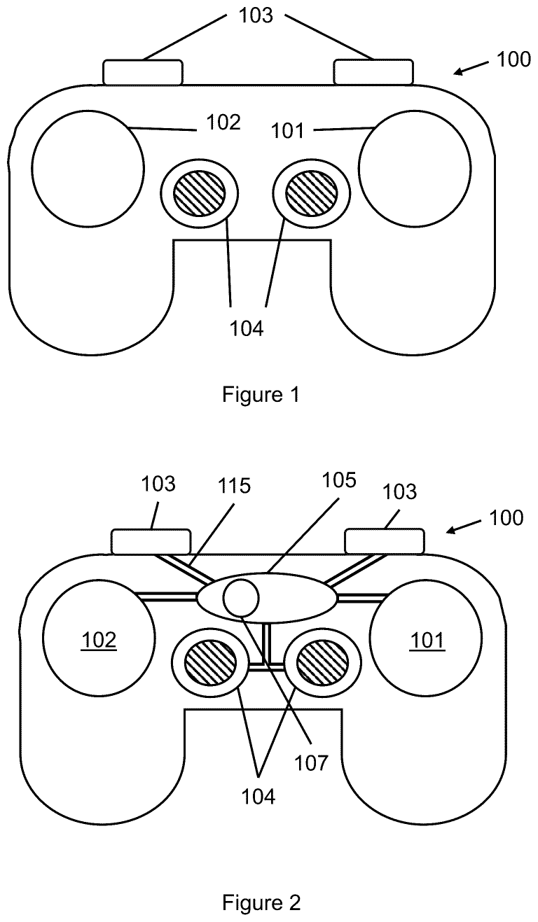

An example controller 100 is shown in FIG. 1. The controller includes a first set of buttons 101, a second set of buttons 102, two sticks or joysticks 104, and two trigger buttons 103. Each of the first set of buttons 101 and the second set of buttons 102 comprises one or more buttons or a plurality of buttons. For example, the first set of buttons 101 and the second set of buttons 102 may each comprise four buttons. It would be understood that the controller 100 can include numerous sensors and circuitry such as a microphone, a gyroscope, an optical sensor, and an accelerometer, as well as other components such as a battery, a charging port, a speaker, a light emitting device and a touch sensitive surface. The controller 100 may also comprise a wireless transceiver for transmitting signals to and receiving signals from a video game system, a controller circuit for controlling the distribution means, a heater and a cooling system. It is to be emphasised that the disclosure is not limited to the example controller 100. Rather, the concepts disclosed below can be applied to various kinds of peripheral devices for video game devices. For example, another kind of peripheral device may have more or less buttons, and have triggers at different locations compared to the triggers 103 shown.

Referring now to FIG. 2, a schematic including the internal structure of the controller 100 is shown. Main reservoir 105 is arranged in the controller, and a number of pipes 115 for transporting fluid radiate out from the main reservoir 105 towards the first set of buttons 101, second set of buttons 102, the joysticks, and the triggers. Also shown schematically is a distribution means 107, which is operable to transport fluid to and from the main reservoir 105 via pipes 115. The distribution means may be implemented as a bi-directional pump or a motor, for example. However, it would be readily understood that any suitable mechanism can be used for providing two-way transportation of the fluid.

The fluid may be any kind of liquid or gas capable of flowing through the pipes 115.

The controller 100 further includes a controller circuit (not shown), which controls the amount of fluid transported by the distribution means 107. The controller can receive signals from a processor of the controller 100 to transport an appropriate amount of fluid to a button, trigger or joystick depending on the level of resistance to movement desired.

It would be understood that each button in the first set of buttons 101 and second set of buttons 102 is individually connected to the main reservoir 105, but this is not shown to avoid overcomplicating the drawings.

When fluid is transported away from the reservoir to a button, for example a button in the first set of buttons 101, the fluid causes the button to have a stronger resistance to movement than normal. Specifically, the resistance to movement may be altered by adjusting a hydraulic pressure exerted on the button, for example by a hydraulic cylinder with a piston connected to the button. When fluid is transported to the hydraulic cylinder, this would affect the resistance to movement of the button. Alternatively, a fillable and expandable cushion could be placed beneath the button, and connected to the pipes 115 in such a way that as fluid is transported to and from the cushion, the expansion and contraction of the cushion results in the resistance to movement of the button being altered.

Accordingly, when the user wants to perform an action associated with the button in a virtual environment they will need to press the button harder, or apply more pressure to the button. The resistance of the button to movement may be proportional to the amount of fluid transported to the button.

To give an example of how this concept can be applied to increase the user's immersion, consider a video game wherein the user can shoot different kinds of projectiles at a target. For example, the user may be able to choose between using gun or using a bow. In real life, the sensation of shooting a gun and shooting a bow are very different. To convey this difference from the virtual environment to the real world, different amounts of fluid may be transported from the main reservoir to one or more of the trigger buttons. When shooting a gun, the resistance to movement might initially be high, but then decrease suddenly as the virtual gun fires. Contrastingly, when shooting a bow, the resistance may initially be relatively low, but increase as the bowstring is pulled back, up to a maximum when the bow is at full draw. It is to be emphasised that this is just one example of how the transporting fluid to a button from a main reservoir can increase the user's immersion.

In this way, the resistance of the buttons to movement can be dynamically adjusted. The adjustment can be based on events and conditions in a virtual environment, thereby conveying sensations from the virtual environment to the user in the real world.

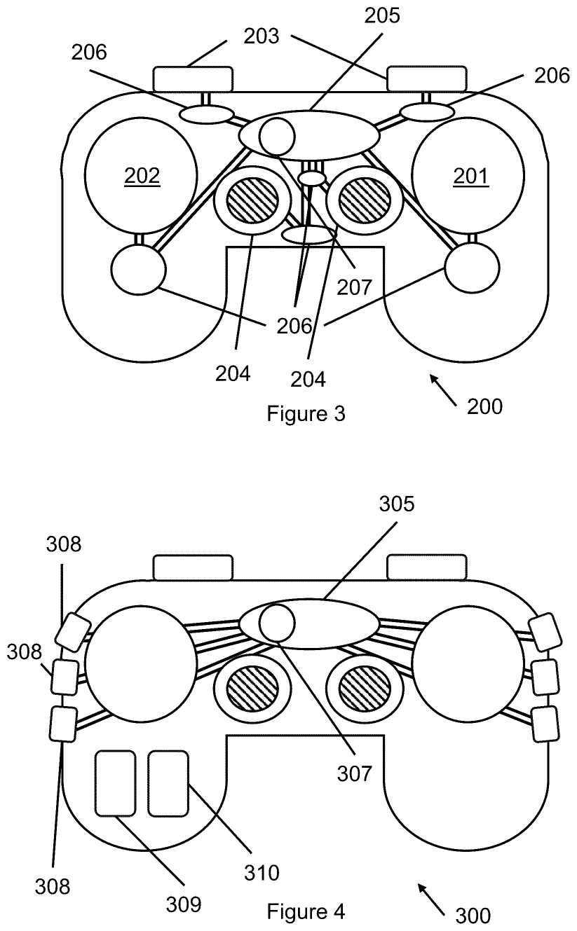

Referring now to FIG. 3, the controller 200 has the same components as the controller 100 shown in FIG. 2, and reference numerals for like components incremented by 100 compared to FIG. 2. Additionally, the controller 200 of FIG. 3 includes a plurality of secondary reservoirs 206. Each of the secondary reservoirs 206 is arranged between the main reservoir 205 and a respective button. Note that to avoid over cluttering the drawings, a single secondary reservoir 206 is shown to be arranged between the main reservoir 205 and each of the first set of buttons 201 and the second set of buttons 202. However, it is to be understood that each of the buttons in the first set of buttons 201 is connected to a respective secondary reservoir 206, and likewise that each of the buttons in the second set of buttons 202 is connected to a respective secondary reservoir 206. Further, each of the triggers 203 and each of the joysticks 204 are provided with a respective secondary reservoir 206. In other words, one secondary reservoir 206 is provided between the main reservoir 205 for each button, trigger or stick.

The provision of a secondary reservoir 206 arranged between the main reservoir 205 and a button, trigger or stick, allows for even more fine-grained control to the resistance to movement of that button trigger or stick, especially in instances where the resistance of multiple buttons are adapted at the same time.

It is to be noted that not every button trigger or stick needs to be provided with a respective secondary reservoir 206. Rather, a subset of the buttons, triggers or sticks could be provided with a secondary reservoir 206. This balances the need to provide fine-grained control with practical constraints such as the available space to arrange the components in controller 200.

Refer now to FIG. 4. Controller 300 includes a main reservoir 305, distribution means 307 and a plurality of force feedback reservoirs 308. The force feedback reservoirs are connected to the main reservoir 305 via tubes or pipes that carry fluid.

The force feedback reservoirs 308 are arranged on the controller 300 in such a way that a part of the user's body, such as the user's fingers or fingertips, will contact them when the user holds the controller 300. A force feedback reservoir 308 can also be provided to contact the user's palm.

The force feedback reservoirs 308 are configured to expand and contract thereby increasing immersion by conveying the sensation of touch from the virtual environment to the real world. That is, because the force feedback reservoirs 308 contact part of the user's body when they expand the user experiences a sensation at that part of the body. To give an example, consider a virtual environment in which the user can pick up virtual items. When the user picks up a virtual item, one or more of the force feedback reservoirs 308 may expand to mimic the sensation the user would experience if they had picked a real world version of the virtual item.

One way to facilitate the expansion and contraction is to use a suitable material, such as silicone or other kinds of flexible polymer used in soft robotics applications.

In this way, the user is given a more realistic touch sensation which does not lead to the user feeling like their fingers are being pulled back to mimic the experience of touch.

Further, the controller 300 may be provided with a heating means 309 which is configured to heat the fluid. The heating means 309 may be realised as a resistive coil. In another implementation, a Peltier device may be used to change the fluid's temperature. Typically, the heating means is connected to the main reservoir 305, thereby allowing the temperature of all fluid transported from the main reservoir 305 to have approximately the same temperature. However, it is also envisioned that the heating means 309 may be configured to heat fluid to be transported to individual force feedback reservoirs 308, thereby providing a finegrained temperature variations across different force feedback reservoirs 308.

Similarly, cooling means 310 may be provided and configured to cool the fluid. The cooling means 310 may be realised as a fan which provides force air cooling of the fluid, or alternatively as a Peltier device. As with the heating means 309, the cooling means 310 is typically configured to cool the fluid in the main reservoir 305, but may alternatively be configured to cool liquid on a per force feedback reservoir 308 basis.

Of course, the present peripheral device is not limited to being a handheld controller. The same concept of providing expanding and contracting force feedback reservoirs that contact the user's body can be applied to different kinds of peripheral devices, such as head mounted devices, gloves, and exoskeleton devices.

It was noted above that the force feedback reservoirs 308 may contact the user's fingertips, or their fingers. Arranging the force feedback reservoirs 308 to contact the user's fingertips is particularly beneficial due to the high density of nerve endings in the fingertips. The user therefore feels a relatively high amount of sensation from the force feedback reservoirs 308.

In other cases, the controller 300 may be provided with an array of force feedback reservoirs 308 per finger, where each array includes multiple force feedback reservoirs. For example, three force feedback reservoirs 308 may be provided for some or all fingers. The force feedback reservoirs 308 may be provided in a hemispheric arrangement to stimulate different parts of a finger and a fingertip. In this way, complex sensations can be conveyed to the user from the virtual environment.

In summary, the present disclosure provides a fine-grained approach to increasing a user's immersion in a virtual environment by transporting fluid to and from a main reservoir to adjust a pressure applied to a moveable component of a peripheral device. It has been discussed that the pressure adjustment of a moveable component of the peripheral device can adjust the resistance to movement of the buttons, sticks or triggers, or the extent to which a force feedback reservoir is expanded or contracted. The use of fluid allows for fine-grained control over the adjustments, leading to the user experiencing an increased sense of immersion.

1. A peripheral device for a video game device, the peripheral device comprising:
a main reservoir configured to be filled with fluid; and
a distribution system connected to the main reservoir and configured to transport fluid to and from the main reservoir,
wherein, in use, fluid is transported to and from the main reservoir to adjust a pressure applied to a moveable component of the peripheral device.

2. The peripheral device of claim 1, further comprising a button,
wherein the button is connected to the distribution system,
wherein the pressure is applied to the button to adjust a resistance to movement of the button,
wherein the resistance to movement of the button varies in proportion to an amount of fluid transported from the main reservoir to the button.

3. The peripheral device of claim 2, wherein the button comprises a plurality of buttons, the distribution system comprises a plurality of secondary reservoirs, and wherein each of the secondary reservoirs is arranged between the main reservoir and a respective button.

4. The peripheral device of claim 1, further comprising a force feedback reservoir connected to the distribution system,
wherein the pressure is applied to the force feedback reservoir to adjust a size of the force feedback reservoir,
wherein in use, the force feedback reservoir is configured to expand and contract, and the force feedback reservoir is configured to be in contact with a part of a user's body, such that the user feels a sensation when the force feedback reservoir expands and contracts.

5. The peripheral device of claim 4, wherein the peripheral device further comprises a heater connected to the main reservoir, wherein the heater is configured in use to heat fluid in the main reservoir.

6. The peripheral device of claim 4, wherein the peripheral device further comprises a cooling device connected to the main reservoir, wherein the cooling device is configured in use to cool fluid in the main reservoir.

7. The peripheral device of claim 4, wherein the force feedback reservoir comprises a plurality of force feedback reservoirs.

8. The peripheral device of claim 4, wherein the part of the user's body comprises the user's fingertips,
wherein the plurality of force feedback reservoirs comprises a respective force feedback reservoir for each of the user's fingertips.

9. The peripheral device of claim 4, wherein the part of the user's body comprises the user's fingers, and
the plurality of force feedback reservoirs comprises a plurality of force feedback reservoirs for each of the user's fingers, wherein the plurality of force feedback reservoirs are arranged to contact different locations on each of the fingers.

10. The peripheral device of claim 1, wherein the distribution means comprises a bi-directional pump.

11. The peripheral device of claim 1, wherein the distribution means comprises a motor.

12. The peripheral device of claim 4, wherein the force feedback reservoir is formed from a material comprising silicone.

13. A system comprising a peripheral device for a video game device, wherein the peripheral device comprises:
a main reservoir configured to be filled with fluid; and
a distribution system connected to the main reservoir and configured to transport fluid to and from the main reservoir,
wherein, in use, fluid is transported to and from the main reservoir to adjust a pressure applied to a moveable component of the peripheral device.

14. The system of claim 13, wherein the peripheral device further comprises a button,
wherein the button is connected to the distribution system,
wherein the pressure is applied to the button to adjust a resistance to movement of the button,
wherein the resistance to movement of the button varies in proportion to an amount of fluid transported from the main reservoir to the button.

15. The system of claim 14, wherein the button comprises a plurality of buttons, the distribution system comprises a plurality of secondary reservoirs, and wherein each of the secondary reservoirs is arranged between the main reservoir and a respective button.

16. The system of claim 13, wherein the peripheral device further comprises a force feedback reservoir connected to the distribution system,
wherein the pressure is applied to the force feedback reservoir to adjust a size of the force feedback reservoir,
wherein in use, the force feedback reservoir is configured to expand and contract, and the force feedback reservoir is configured to be in contact with a part of a user's body, such that the user feels a sensation when the force feedback reservoir expands and contracts.

17. A method comprising:
adjusting a pressure applied to a movement component of a peripheral device, wherein adjusting the pressure comprises:
transporting fluid, by a distribution system, to and from a main reservoir of the peripheral device, wherein the main reservoir is configured to be filled with fluid, and wherein the distribution system is connected to the main reservoir and configured to transport fluid to and from the main reservoir.

18. The method of claim 17, wherein the peripheral device further comprise a button, wherein the button is connected to the distribution system, and further comprising:
adjusting a resistance to movement of the button by applying the pressure to the button;
wherein the resistance to movement of the button varies in proportion to an amount of fluid transported from the main reservoir to the button.

19. The method of claim 18, wherein the button comprises a plurality of buttons, the distribution system comprises a plurality of secondary reservoirs, and wherein each of the secondary reservoirs is arranged between the main reservoir and a respective button.

20. The method of claim 17, wherein the peripheral device further comprises a force feedback reservoir that is configured to expand and contract and is connected to the distribution system, and further comprising:
adjusting a size of the force feedback reservoir by applying the pressure to the force feedback reservoir, wherein the force feedback reservoir is configured to be in contact with a part of a user's body, such that the user feels a sensation when the force feedback reservoir expands and contracts.
